(19) United States
(12) Patent Application Publication
(10) Pub. No.: US 2012/0148029 A1
(43) Pub. Date: Jun. 14, 2012

(54) GRID FOR USE IN RADIATION IMAGING, METHOD FOR PRODUCING THE SAME, AND RADIATION IMAGING SYSTEM

(75) Inventor: Yasuhisa KANEKO, Ashigarakami-gun (JP)

(73) Assignee: FUJIFILM CORPORATION, Tokyo (JP)

(21) Appl. No.: 13/308,013

(22) Filed: Nov. 30, 2011

(30) Foreign Application Priority Data
Dec. 14, 2010 (JP) 2010-277949

(51) Int. Cl. G21K 1/10; B21D 39/03

(52) U.S. Cl. 378/154; 29/428

(57) ABSTRACT

First and second grids are arranged between an X-ray source and an X-ray image detector. The first and second grids have the similar configuration except for width, pitch, and thickness of X-ray absorbing sections. The first grid is composed of subdivision grids arranged with substantially no space between each other on a flat surface of a substrate made of glass, for example. Each subdivision grid has a shape of a regular hexagon. Each subdivision grid has the X-ray absorbing sections and X-ray transmitting sections extending in Y direction and arranged alternately in X direction. The X-ray absorbing sections of the adjacent subdivision grids are aligned substantially parallel to each other. The X-ray transmitting sections of the adjacent subdivision grids are aligned substantially parallel to each other. No side of the subdivision grid is parallel to an extending direction of the X-ray absorbing sections and the X-ray transmitting sections.

### BACKGROUND OF THE INVENTION

1. Field of the Invention

The present invention relates to a grid for use in radiation imaging using, for example, X-rays, a method for producing a grid, and a radiation imaging system.

2. Description Related to the Prior Art

When incident on an object, radiation (for example, X-rays) changes its intensity and phase due to interaction with the object. It is known that the phase change (angular change) interacts more strongly than the intensity change with the object. X-ray phase imaging takes advantage of this property. Using the X-ray phase imaging technique, a high contrast image (hereinafter referred to as the phase contrast image) of an object with low X-ray absorption is captured based on the phase change of the X-rays caused by the object. Researches on the X-ray phase imaging have been conducted actively.

An X-ray imaging system using Talbot effect caused by two transmission-type diffraction gratings (grids) has been known as one type of X-ray phase imaging (for example, U.S. Pat. No. 7,180,979 corresponding to Japanese Patent No. 4445397, “Differential X-ray Phase contrast imaging using a shearing interferometer” C. David, et al., Applied Physics Letters, page 3287, Vol. 81, No. 17, October 2002). In this X-ray imaging system, a first grid is arranged behind an object when viewed from an X-ray source. A second grid is arranged downstream from the first grid by a Talbot length. An X-ray image detector is arranged behind the second grid. The X-ray image detector detects X-rays to generate an image. Each of the first and second grids is a stripe-like grid having X-ray absorbing sections and X-ray transmitting sections. The X-ray absorbing sections and the X-ray transmitting sections extend in one direction and are arranged alternately in an arranging direction orthogonal to the extending direction. The Talbot length refers to a distance at which the X-rays passed through the first grid form a self image due to Talbot effect. The self image is modulated by interaction between the object and the X-rays.

In the X-ray imaging system, a fringe image is generated by superposition of the self image of the first grid onto the second grid, that is, the intensity modulation of the self image by the second grid. The fringe image is detected by an X-ray image detector. To be more specific, based on a fringe scanning method, phase information of the object is obtained from changes in the fringe image caused by the object. In the fringe scanning method, an image is captured every time the second grid is moved translationally relative to the first grid. The second grid is moved substantially parallel to a surface of the first grid in a direction substantially vertical to a grid direction of the first grid at a scan pitch which is one of equally-divided parts of a grid pitch. Angular distribution of the X-rays refracted by the object is obtained from changes in intensity in each of pixel values detected by the X-ray image detector. Based on the angular distribution, a phase contrast image of the object is obtained. The fringe scanning method is also applied to an imaging apparatus using laser light (for example, see “Improved phase-shifting method for automatic processing of moiré deflectograms”, Hector Canabal et al., Applied Optics, Vol. 37, No. 26, September 1998, page 6227).

Such X-ray imaging system has been developed for use in medical diagnosing. To capture an image of a large object such as a patient, the X-ray image detector and the first and second grids need to be upsized. Each of the first and second grids has a microstructure in which the X-ray absorbing sections and the X-ray transmitting sections are arranged alternately at the pitch of the order of μm. Accordingly, it is difficult to produce a large grid at a time. To solve this problem, it is suggested to arrange rectangular subdivision grids next to one another to produce a large grid (see U. S. Patent Application Publication No. 2007/0183562 corresponding to Japanese Patent Laid-Open Publication No. 2007-203061).

Each of the first and second grids is produced by forming the X-ray absorbing sections and the X-ray transmitting sections into a pattern on a substrate made of glass or silicon, for example. When a silicon substrate is used, a semiconductor process such as photolithography is used.

The silicon substrate used in the semiconductor process is a silicon wafer substantially circular in shape. To produce the above-described rectangular subdivision grid, a rectangular silicon wafer is cut out from the circular silicon wafer, leaving remains as wastes. This results in low productivity.

When the rectangular subdivision grids are arranged as described in the U. S. Patent Publication Application No. 2007/0183562, edges of the adjacent subdivision grids are arranged linearly in horizontal and vertical directions. As a result, the entire grid is susceptible to bending in the horizontal and vertical directions along the edges of the subdivision grids, resulting in low durability to external force.

### SUMMARY OF THE INVENTION

An object of the present invention is to provide a grid for use in radiation imaging, with high productivity and high durability against external force, a method for producing a grid, and a radiation imaging system using a grid.

To achieve the above and other objects, a grid of the present invention for use in radiation imaging includes a plurality of first subdivision grids and a plurality of second subdivision grids. Each of the first subdivision grids has a shape of a regular polygon. The regular polygon has the number of angles greater than that of a rectangle. The second subdivision grids are the same as or different from the first subdivision grids in shape. The first and the second subdivision grids are arranged with substantially no space between each other.

It is preferable that each of the first subdivision grids has a shape of a regular hexagon. In this case, the second subdivision grids are the same as the first subdivision grids in shape.

It is preferable that each of the first subdivision grids has a shape of a regular octagon. In this case, each of the second grids has a shape of a square.

It is preferable that each of the first and second subdivision grids has a plurality of radiation absorbing sections and a plurality of radiation transmitting sections. It is preferable that the radiation absorbing sections and the radiation transmitting sections extend in one direction and are arranged alternately in a direction orthogonal to the one direction.

It is preferable that the radiation absorbing sections of the adjacent subdivision grids are aligned substantially parallel to each other, and the radiation transmitting sections of the adjacent subdivision grids are aligned substantially parallel to each other.

It is preferable that no side of the first and second subdivision grids is parallel to the one direction.

It is preferable that the grid further includes a substrate having a flat or concave surface. The first and second subdivision grids are arranged on the surface.

A method for producing a grid for use in radiation imaging includes a forming step, a cutting step, a step for repeating the forming step and the cutting step, and an arranging step. In the forming step, a subdivision grid is formed on a substantially circular substrate. The subdivision grid has a shape of a regular polygon. The regular polygon has the number of angles greater than that of a rectangle. In the cutting step, the subdivision grid is cut out from the substantially circular substrate. The forming step and the cutting step are repeated to produce a plurality of the subdivision grids. In the arranging step, the subdivision grids are arranged with substantially no space between each other on a flat or concave surface of a support substrate.

A radiation imaging system includes a first grid, a second grid, and a radiation image detector. The first grid allows radiation from a radiation source to pass therethrough to generate a first periodic pattern image. The second grid partly shields the first periodic pattern image to generate a second periodic pattern image. The radiation image detector detects the second periodic pattern image. The grid of the present invention is used as at least one of the first and second grids.

The grid for use in radiation imaging according to the present invention is composed of a plurality of first subdivision grids and a plurality of second subdivision grids arranged with substantially no space between each other. Each of the first subdivision grids has a shape of a regular polygon with the number of angles greater than that of a rectangle. The second subdivision grids are the same as or different from the first subdivision grids in shape. Accordingly, the grid of the present invention improves both in productivity and durability against external force.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic view of an X-ray imaging system of a first embodiment;

FIG. 2 is a plan view of a first grid;

FIG. 3 is a cross-sectional view taken along a line A-A in FIG. 2;

FIGS. 4A to 4G are cross-sectional views showing steps for producing the first grid;

FIG. 5 is a plan view of a silicon wafer on which a subdivision grid is formed;

FIG. 6 is a plan view of a first grid according to a second embodiment;

FIG. 7A is a plan view of a silicon wafer on which a first subdivision grid is formed;

FIG. 7B is a plan view of a silicon wafer on which second subdivision grids are formed;

FIG. 8A is a plan view of a first grid according to a third embodiment;

FIG. 8B is a cross-sectional view taken along a line B-B in FIG. 8A; and

FIG. 8C is a cross-sectional view taken along a line C-C in FIG. 8A.

### DESCRIPTION OF THE PREFERRED EMBODIMENTS

### First Embodiment

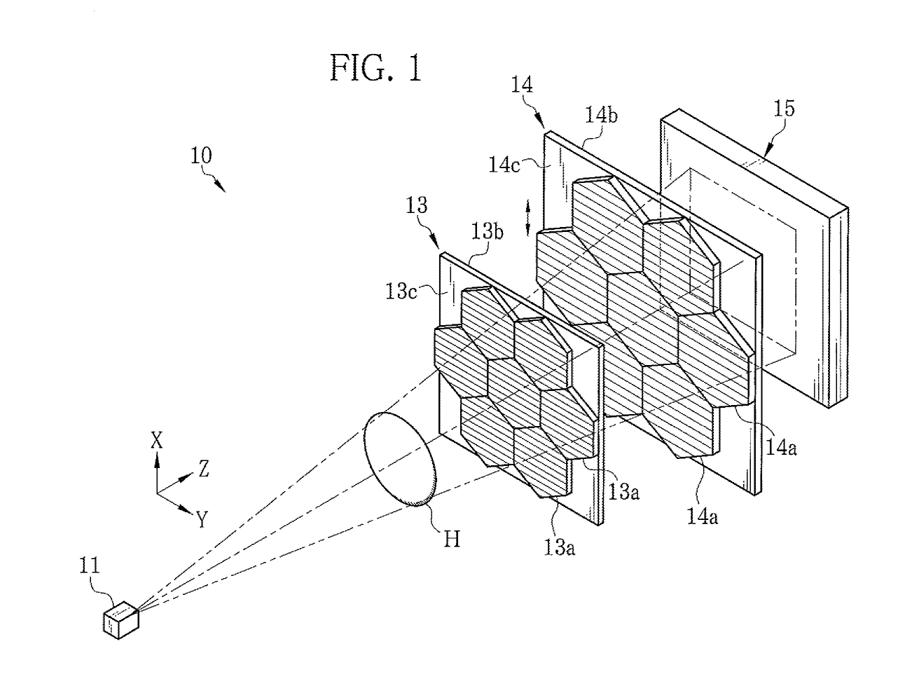

In FIG. 1, a radiation imaging system, for example, an X-ray imaging system 10 includes an X-ray source 11, a first grid 13, a second grid 14, and an X-ray image detector 15. The X-ray source 11 has a rotating-anode type X-ray tube and a collimator for limiting an X-ray field, for example. The X-ray source 11 applies X-rays to an object H. Each of the first grid 13 and the second grid 14 is an absorption grid that absorbs X-rays. The first and second grids 13 and 14 face the X-ray source 11 in Z direction that is a direction of the X-ray emission. Between the X-ray source 11 and the first grid 13, there is a clearance large enough to arrange the object H. The X-ray image detector 15 is, for example, a flat panel detector (FPD) having a semiconductor circuit. The X-ray image detector 15 is arranged behind the second grid 14.

The first grid 13 includes a plurality of subdivision grids 13a and a substrate 13b. Each subdivision grid 13a has a shape of a regular hexagon. On a flat surface 13c of the substrate 13b, the subdivision grids 13a are arranged with substantially no space between each other. Similarly, the second grid 14 includes a plurality of subdivision grids 14a and a substrate 14b. Each subdivision grid 14a has a shape of a regular hexagon. On a flat surface 14c of the substrate 14b, the subdivision grids 14a are arranged with substantially no space between each other.

Next, a configuration of the first grid 13 is described by way of example. The second grid 14 has the same configuration as the first grid 13 except for the size, so the description of the second grid 14 is omitted.

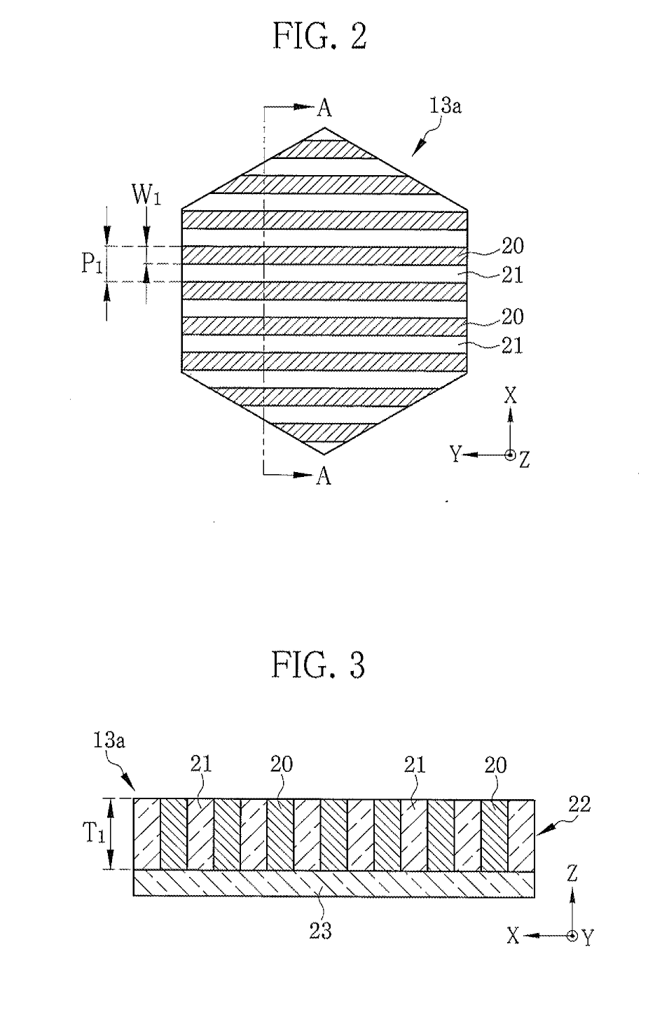

As shown in FIGS. 2 and 3, each subdivision grid 13a includes a grid layer 22 and a conductive layer 23. The grid layer 22 is composed of a plurality of X-ray absorbing sections 20 and a plurality of X-ray transmitting sections 21. Each X-ray absorbing section 20 is made of X-ray absorptive metal, for example, gold (Au) or platinum (Pt) and has X-ray absorption property. Each X-ray transmitting section 21 is made from single crystal silicon and has X-ray transmission property. The conductive layer 23 is made of X-ray absorptive metal, for example, chromium (Cr).

The X-ray absorbing sections 20 and the X-ray transmitting sections 21 extend in Y direction that is a direction in a plane orthogonal to the Z direction. The X-ray absorbing sections 20 and the X-ray transmitting sections 21 are arranged alternately in X direction orthogonal to the Y and Z directions. Thus, the X-ray absorbing sections 20 and the X-ray transmitting sections 21 form a stripe-like pattern. The X-ray absorbing sections 20 and the X-ray transmitting sections 21 are formed such that they extend orthogonally to opposing sides of the hexagonal subdivision grid 13a. In other words, the X-ray absorbing sections 20 and the X-ray transmitting sections 21 extend in a direction non-parallel to any of the sides of the hexagonal subdivision grid 13a.

When the subdivision grids 13a are arranged with substantially no space between each other as shown in FIG. 1, the X-ray absorbing sections 20 of the adjacent subdivision grids 13a are aligned substantially parallel to each other. The X-ray transmitting sections 21 of the adjacent subdivision grids 13a are aligned substantially parallel to each other.

A width W₁ of each X-ray absorbing section 20 in the X direction and an arrangement pitch P₁ between the X-ray absorbing sections 20 in the X direction are determined based on a distance between the X-ray source 11 and the first grid 13, a distance between the first grid 13 and the second grid 14, and a pitch between the X-ray absorbing sections 20 of the second grid 14, for example. The width W₁ is approximately 2 μm to 20 μm, for example. The pitch P₁ is of the order of 4 μm to 40 μm, twice as long as the width W₁. The thickness T₁ of the X-ray absorbing section 20 in the Z direction is, for example, of the order of 100 μm in consideration of vignetting of the cone-beam shaped X-rays emitted from the X-ray source 11.

Next, an operation of the X-ray imaging system 10 is described. A phase of the X-rays applied from the X-ray source 11 changes when the X-rays traverse the object H. Then the X-rays pass through the first grid 13. Thereby, a first periodic pattern image is formed. The first periodic pattern image carries transmission phase information of the object H, which is determined by a refractive index of the object H and a transmission optical path length.

The second grid 14 partly shields the first periodic pattern image to change its intensity. Thereby, a second periodic pattern image is formed. In this embodiment, based on a fringe scanning method, the second grid 14 is moved translationally relative to the first grid 13. Namely, the second grid 14 is moved about the X-ray focal point in the X direction along a surface of the first grid 13 at a scan pitch which is one of equally-divided parts (for example, five equally-divided parts) of a grid pitch. Every time the second grid 14 is moved translationally relative to the first grid 13, the X-ray source 11 applies the X-rays to the object and the image detector 15 captures the second periodic pattern image. By calculating the phase shift of an intensity modulation signal of each pixel in the X-ray image detector 15, a differential phase image is obtained. The intensity modulation signal is a waveform signal representing intensity modulation of pixel data relative to the translational movement of the second grid 14. The differential phase image corresponds to the angular distribution of the X-rays refracted by the object. The differential phase image is integrated in the direction of the fringe scanning. Thereby, the phase contrast image of the object H is obtained.

Next, a method for producing the first grid 13 is described. Note that the second grid 14 is produced in the same manner as the first grid 13, so the description thereof is omitted.

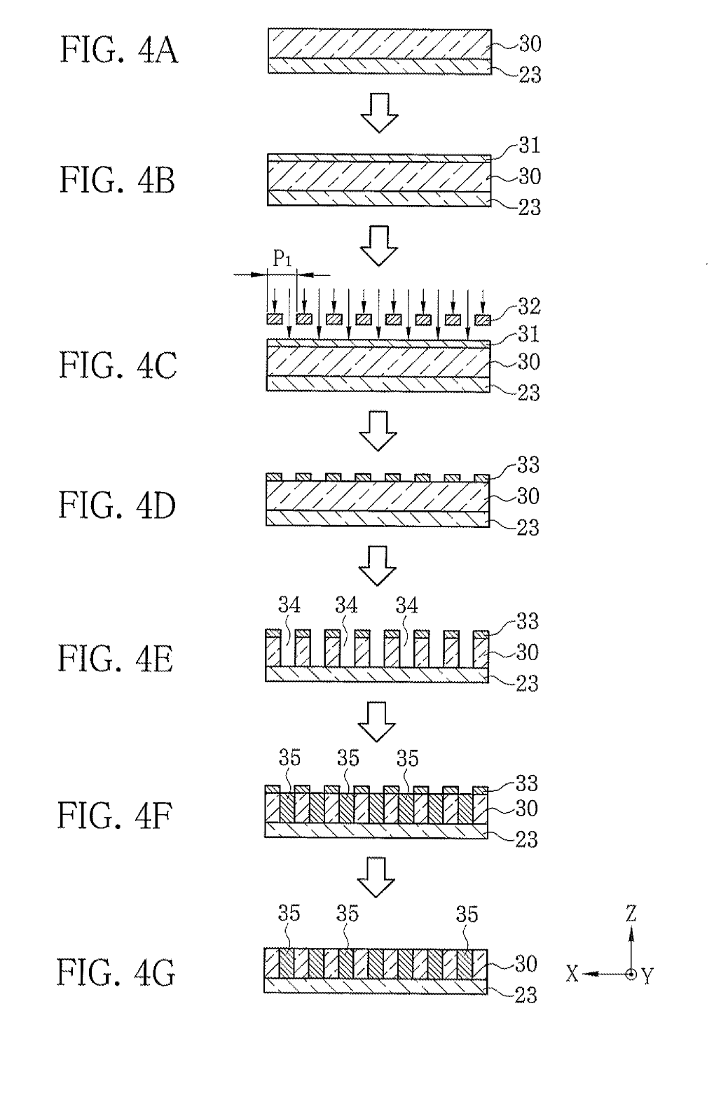

As shown in FIG. 4A, first, the conductive layer 23 is formed by bonding or vapor deposition on an undersurface of a silicon wafer 30. The silicon wafer 30 is a substantially circular substrate made from single crystal silicon used in a common semiconductor process. The conductive layer 23 is made of a conductive material, for example, chromium. It is preferable that there is a small difference in thermal expansion coefficient between the conductive layer 23 and the silicon wafer 30. The conductive layer 23 may be made of kovar or invar, for example. To bond the substrate-like conductive layer 23 to the silicon wafer 30, diffusion bonding or room temperature bonding is used, for example. The diffusion bonding is a joining process performed while heat and pressure are applied. The room temperature bonding or surface activated bonding is a joining process in which surfaces of the conductive layer 23 and the silicon wafer 30 are activated in high vacuum.

In a next step, as shown in FIG. 4B, a resist layer 31 is formed on an upper surface of the silicon wafer 30. The resist layer 31 is formed by a coating step and a prebaking step, for example. In the coating step, liquid resist is applied to the silicon wafer 30 using a coating method such as spin coating. Then in the prebaking step, organic solvent is evaporated from the liquid resist applied to the silicon wafer 30.

Thereafter, as shown in FIG. 4C, light, for example, UV rays are applied to the resist layer 31 through an exposure mask 32. The exposure mask 32 has a striped pattern with the pitch P₁. Then, as shown in FIG. 4D, portions of the resist layer 31 exposed to the UV rays are removed by a developing process. Thereby, an etch mask 33 is formed on the silicon wafer 30. The etch mask 33 has a striped pattern composed of a plurality of linear patterns extending in the Y direction and arranged in the X direction. Note that the resist layer 31 is a positive resist. Alternatively, a negative resist may be used.

In a next step, as shown in FIG. 4E, a dry etching process is performed through an etch mask 33a to form a plurality of grooves 34 on the silicon wafer 30. The grooves 34 extend in the Y direction and are arranged in the X direction. Here, Bosch process is used as the dry etching process. The Bosch process is a deep dry etching process that allows forming of the grooves 34 with a high aspect ratio. Alternatively, a cryo process may be used.

In a next step, as shown in FIG. 4F, an X-ray absorbing member 35, for example, gold (Au) is filled in each of the grooves 34 by an electroplating method using the conductive layer 23 as a seed layer. In this electroplating method, a joined substrate composed of the silicon wafer 30 and the conductive layer 23 is immersed in a plating liquid. One of electrodes (anode) is positioned to oppose the joined substrate. A current is applied between the conductive layer 23 and the other electrode. Thereby, metal ions in the plating liquid are deposited on the pattern-processed substrate. Thus, each of the grooves 34 is filled with the X-ray absorbing member 35.

Thereafter, as shown in FIG. 4G, the etch mask 33 is removed from the silicon wafer 30 by asking, for example. Thus, a grid structure of the subdivision grid 13a is formed. Here, the X-ray absorbing member 35 corresponds to the X-ray absorbing section 20. A portion of the silicon wafer 30 adjacent to the X-ray absorbing member 35 corresponds to the X-ray transmitting section 21. Thereafter, the conductive layer 23 may be removed from the silicon wafer 30.

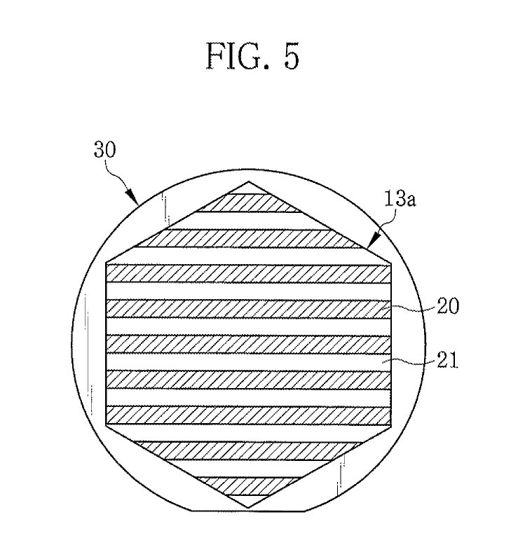

By following the above steps, as shown in FIG. 5, the subdivision grid 13a is formed on the silicon wafer 30. The subdivision grid 13a is cut out from the silicon wafer 30 using a dicing device used in a common semiconductor process. The dicing device cuts out the subdivision grid 13a from the silicon wafer 30, one side of the regular hexagon at a time, rotating the silicon wafer by 60 degrees for each cut. In this embodiment, each subdivision grid 13a is hexagonal in shape. This reduces remains of the silicon wafer 30 after cutting, compared with conventional rectangular subdivision grids. Accordingly, the productivity improves.

The above steps are performed repeatedly or in parallel to form the subdivision grids 13a. Finally, the subdivision grids 13a are arranged with substantially no space between each other on the flat surface 13c of the substrate 13b made of glass, for example. Thus, the first grid 13 is produced. The subdivision grids 13a are joined to the substrate 13b using an adhesive, for example. The subdivision grids 13a are aligned with each other based on positions of their sides and positions of the X-ray absorbing sections 20 and the X-ray transmitting sections 21. Alignment marks for positioning the subdivision grids 13a may be provided on the flat surface 13c of the substrate 13b.

In this embodiment, each of the subdivision grids 13a and 14a has the shape of a regular hexagon that is a regular polygon having the number of angles greater than that of a rectangle or quadrilateral. The subdivision grids 13a are arranged with substantially no space between each other to form the first grid 13. The subdivision grids 14a are arranged with substantially no space between each other to form the second grid 14. Accordingly, the productivity improves. Adjacent boundaries between the subdivision grids 13a are out of alignment with each other. Adjacent boundaries between the subdivision grids 14a are out of alignment with each other. Thereby, the first and second grids 13 and 14 are resistant to bending, and thus durability against external force improves.

When a side of the hexagonal subdivision grid 13a or 14a is parallel to the extending direction of the X-ray absorbing sections 20 and the X-ray transmitting sections 21, the side parallel to the extending direction causes grid line artifact in the phase contrast image. In this embodiment, however, no side of the subdivision grids 13a and 14a is parallel to the extending direction of the X-ray absorbing sections 20 and the X-ray transmitting sections 21. This prevents the artifact.

Hereinafter, other embodiments of the present invention are described. In the following embodiments, for the configuration similar to that described in the first embodiment, like numerals describe like parts and the descriptions thereof are omitted. In the following embodiments, the second grid has the similar configuration to the first grid except for the grid pitch, the thickness, and the like. A method for producing the second grid is similar to that of the first grid. Accordingly, the descriptions of the second grid are omitted.

### Second Embodiment

In the first embodiment, each of the first and second grids is formed by arranging one kind of subdivision grids with substantially no space between each other. Alternatively, two or more kinds of subdivision grids may be arranged with substantially no space between each other. The two or more kinds of subdivision grids differ in shape.

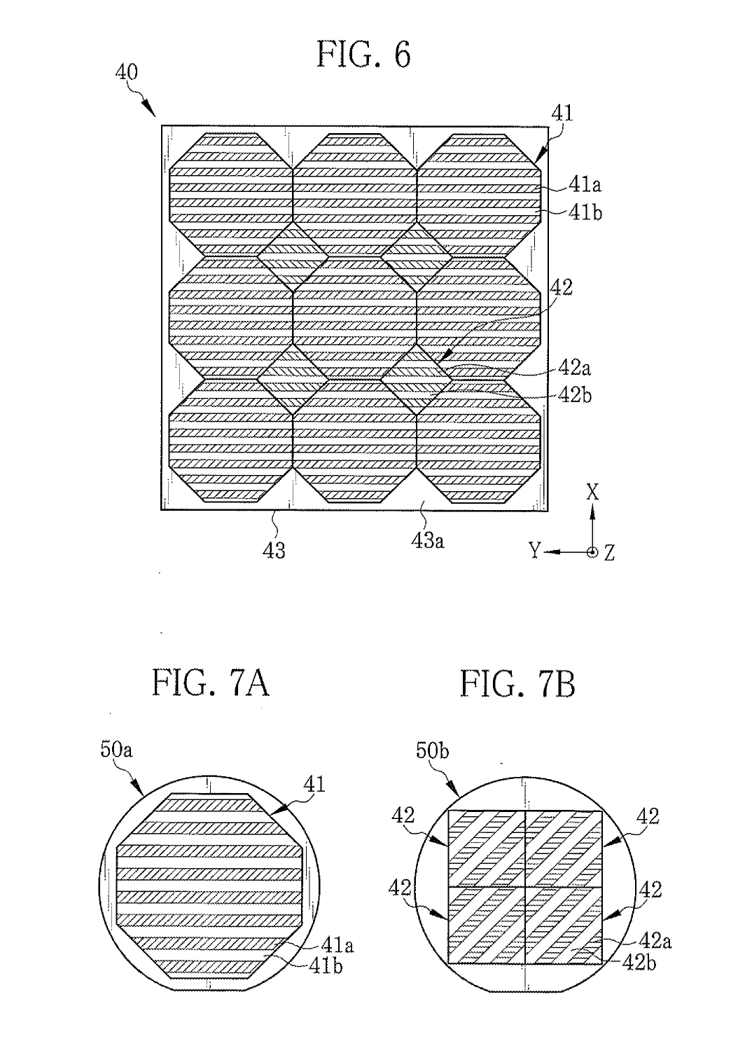

As shown in FIG. 6, a first grid 40 is composed of first subdivision grids 41, second subdivision grids 42, and a substrate 43. Each of the first subdivision grids 41 has a shape of a regular octagon. Each of the second subdivision grids 42 has a shape of a square. On a flat surface 43a of the substrate 43, the first and second subdivision grids 41 and 42 are arranged with substantially no space between each other. The length of one side of the second subdivision grid 42 is equal to that of the first subdivision grid 41. The first and second subdivision grids 41 and 42 are arranged such that each side of the second subdivision grid 42 is in contact with a side of the first subdivision grid 41, namely, each second subdivision grid 42 is surrounded by four first subdivision grids 41.

Each of the first subdivision grids 41 is provided with a plurality of X-ray absorbing sections 41a and a plurality of X-ray transmitting sections 41b. The X-ray absorbing sections 41a and the X-ray transmitting sections 41b extend in the Y direction, and are arranged alternately in the X direction. Similarly, each of the second subdivision grids 42 is provided with a plurality of X-ray absorbing sections 42a and a plurality of X-ray transmitting sections 42b. The X-ray absorbing sections 42a and the X-ray transmitting sections 42b extend in the Y direction, and are arranged alternately in the X direction.

The X-ray absorbing sections 41a of the first subdivision grid 41 and the X-ray absorbing sections 42a of the second subdivision grid 42 are formed such that the X-ray absorbing sections 41a and 42a of the adjacent first and second subdivision grids 41 and 42 are aligned substantially parallel to each other, and the X-ray absorbing sections 41a of the adjacent first subdivision grids 41 are aligned substantially parallel to each other, when the first and second subdivision grids 41 and 42 are arranged with substantially no space between each other.

The grid structure of the first subdivision grid 41 and the grid structure of the second subdivision grid 42 are produced according to the method described in the first embodiment. In the dicing process, as shown in FIG. 7A, one first subdivision grid 41 is cut out from each silicon wafer 50a. As shown in FIG. 7B, four second subdivision grids 42 are cut out from each silicon wafer 50b.

### Third Embodiment

In the first embodiment, the subdivision grids are arranged on a flat plate-like substrate to produce each of the first and second grids. Alternatively, the subdivision grids may be arranged on a concave surface of a substrate.

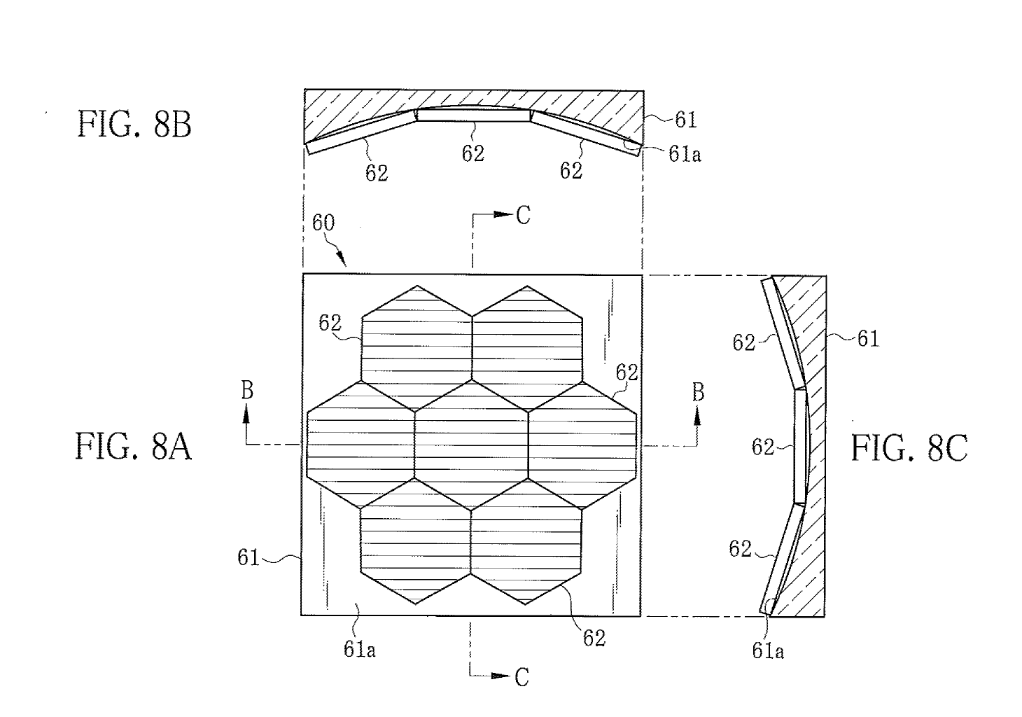

As shown in FIGS. 8A to 8C, a first grid 60 includes a plurality of subdivision grids 62 and a substrate 61. On a concave surface 61a of the substrate 61, the subdivision grids 62 are arranged with substantially no space between each other.

The subdivision grid 62 has the same configuration as the subdivision grid 13a of the first embodiment. The subdivision grid 62 has a shape of a regular hexagon. The shape of the concave surface 61a of the substrate 61 coincides with a spherical surface having a focal point of the X-ray source 11 as the center. The X-rays emitted from the X-ray source 11 are incident substantially vertically on the concave surface 61a.

Each of the first and second grids may be composed of two or more kinds of subdivision grids as described in the second embodiment. The two or more kinds of subdivision grids are arranged with substantially no space between each other on the concave surface of the substrate.

### Other Embodiments

In the above embodiments, the present invention is described using the first and second grids by way of example. The present invention is also applicable to an X-ray source grid (multi-slit) provided on an emission side of the X-ray source 11.

In the above embodiments, the first grid is configured to project the X-rays, passed through its X-ray transmitting sections, in a geometrical-optical manner. Alternatively, the X-rays may be diffracted by the X-ray transmitting sections to cause the so-called Talbot effect (for example, see U.S. Pat. No. 7,180,979 corresponding to Japanese Patent No. 4445397). In this case, a distance between the first and second grids needs to be set to a Talbot length. Instead of the absorption grid, a phase grid can be used as the first grid. A self image is formed at the position of the second grid due to the Talbot effect.

In the above embodiments, by way of example, the phase contrast image is generated from multiple image captures performed while the relative position between the first and second grids is changed. Alternatively, the phase contrast image can be generated by a single image capture with the first and second grids being fixed. For example, in an X-ray imaging system disclosed in U. S. Patent Application Publication No. 2011/0158493 (corresponding to WO 2010/050483), an X-ray image detector detects moiré fringes generated by using the first and second grids. Intensity distribution of the moiré fringes is subjected to Fourier transform to obtain a spatial frequency spectrum. A spectrum corresponding to a carrier frequency is separated from the spatial frequency spectrum, and inverse Fourier transform is performed. Thereby, a differential phase image is obtained. The grid of the present invention is also suitable for this X-ray imaging system.

In the above embodiments, the object H is arranged between the X-ray source and the first grid. Alternatively, the object H may be arranged between the first grid and the second grid. This configuration also allows the generation of the phase contrast image. The substrate may not be used for each of the first and second grids.

The above embodiments are applicable to radiation imaging systems for use in medical diagnosing, industrial applications, and non-destructive examinations, for example. The present invention is also applicable to an anti-scatter grid for removing scattered radiation during the X-ray imaging. Radiation other than X-rays, for example, gamma rays can be used in the present invention.

Various changes and modifications are possible in the present invention and may be understood to be within the present invention.

What is claimed is:

1. A grid for use in radiation imaging comprising:
a plurality of first subdivision grids, each of the first subdivision grids having a shape of a regular polygon, the regular polygon having number of angles greater than that of a rectangle; and
a plurality of second subdivision grids, the second subdivision grids being same as or different from the first subdivision grids in shape;
wherein the first and the second subdivision grids are arranged with substantially no space between each other.

2. The grid of claim 1, wherein each of the first subdivision grids has a shape of a regular hexagon, and the second subdivision grids are the same as the first subdivision grids in shape.

3. The grid of claim 1, wherein each of the first subdivision grids has a shape of a regular octagon, and each of the second subdivision grids has a shape of a square.

4. The grid of claim 1, wherein each of the first and second subdivision grids has a plurality of radiation absorbing sections and a plurality of radiation transmitting sections, and the radiation absorbing sections and the radiation transmitting sections extend in one direction and are arranged alternately in a direction orthogonal to the one direction.

5. The grid of claim 4, wherein the radiation absorbing sections of the adjacent subdivision grids are aligned substantially parallel to each other, and the radiation transmitting sections of the adjacent subdivision grids are aligned substantially parallel to each other.

6. The grid of claim 4, wherein no side of the first and second subdivision grids is parallel to the one direction.

7. The grid of claim 1, further including a substrate having a flat or concave surface, the first and second subdivision grids being arranged on the surface.

8. A method for producing a grid for use in radiation imaging, comprising the steps of:
(A) forming a subdivision grid on a substantially circular substrate, the subdivision grid having a shape of a regular polygon, the regular polygon having number of angles greater than that of a rectangle;
(B) cutting, out the subdivision grid from the substantially circular substrate;
(C) repeating the steps (A) and (B) to produce a plurality of the subdivision grids; and
(D) arranging the subdivision grids with substantially no space between each other on a flat or concave surface of a support substrate.

9. A radiation imaging system comprising:
a first grid allowing radiation from a radiation source to pass therethrough to generate a first periodic pattern image;
a second grid partly shielding the first periodic pattern image to generate a second periodic pattern image; and
a radiation image detector for detecting the second periodic pattern image;
wherein a grid for use in radiation imaging is used as at least one of the first and second grids, the grid includes a plurality of first subdivision grids and a plurality of second subdivision grids, and each of the first subdivision grids has a shape of a regular polygon, and the regular polygon has number of angles greater than that of a rectangle, and the second subdivision grids are same as or different from the first subdivision grids in shape, and the first and second subdivision grids are arranged with substantially no space between each other.
